(19) United States
(12) Patent Application Publication
(10) Pub. No.: US 2008/0298374 A1
(43) Pub. Date: Dec. 4, 2008

(54) APPARATUS FOR MONITORING NETWORK CONNECTIVITY

(75) Inventors: RICHARD RHOADES, DECATUR, TX (US); JOHN-PAUL ROADMAN, CARROLLTON, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/757,842

(22) Filed: Jun. 4, 2007

(51) Int. Cl. H04L 12/56

(52) U.S. Cl. 370/397

(57) ABSTRACT

An apparatus for monitoring network connectivity is disclosed. A system that incorporates teachings of the present disclosure may include, for example, a network device having a controller element to route packets to one or more locations of a virtual private network utilizing Virtual Routing and Forwarding (VRF) functionality, and route a connectivity message to a connectivity server in response to receiving a query for connectivity information. The query can be grouped with at least one other query for at least one among a border network device of a service provider and a customer network device of the virtual private network. Additional embodiments are disclosed.

### FIELD OF THE DISCLOSURE

The present disclosure relates generally to communication systems, and more specifically to an apparatus for monitoring network connectivity.

### BACKGROUND

Communication networks are subject to various adverse conditions that can disable connections, such as a connection between remote locations of a virtual private network. Pings (or message queries) can be used to test a connection. However, where Virtual Routing and Forwarding (VRF) functionality is being implemented by the various network devices of the network, the use of pings can require a large bandwidth usage and processing time.

A need therefore arises for an apparatus for monitoring network connectivity.

### BRIEF DESCRIPTION OF THE DRAWINGS

FIGS. 1-3 depict exemplary embodiments of a communication system;

FIG. 4 depicts an exemplary method operating in one or more of the communication systems of FIGS. 1-3; and

FIG. 5 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide an apparatus for monitoring network connectivity.

In a first embodiment of the present disclosure, a computer-readable storage medium can have computer instructions for grouping connectivity queries for routers comprising border routers of a service provider and customer routers of a virtual private network, where the service provider provides the virtual private network with a plurality of remote locations, where the customer routers are located in each of the plurality of remote locations, and where the grouping is based at least in part on an association between the routers; querying the border routers and the customer routers of each of the plurality of remote locations to obtain connectivity information, wherein the border routers and the customer routers utilize Virtual Routing and Forwarding (VRF) functionality; and verifying connectivity between the plurality of remote locations based on the connectivity information.

In a second embodiment of the present disclosure, a network device can have a controller element to route packets to one or more locations of a virtual private network utilizing VRF functionality; and route a connectivity message to a connectivity server in response to receiving a query for connectivity information, wherein the query is grouped with at least one other query for at least one among a border network device of a service provider and a customer network device of the virtual private network.

In a third embodiment of the present disclosure, a communication device can have a controller element to transmit packets that are routed to one or more customer locations of a virtual private network utilizing VRF functionality, wherein a connectivity between a plurality of locations of the virtual private network is verified based in part on a connectivity message that is sent by a network device to a connectivity server in response to receiving a query for connectivity information, and wherein the query is grouped with at least one other query for at least one among a border network device of a service provider and a customer network device of the virtual private network.

In a fourth embodiment of the present disclosure, a network device can have a controller element to route packets to one or more locations of a virtual private network utilizing Virtual Routing and Forwarding (VRF) functionality; receive a first query for connectivity information; and route a second query for connectivity information to at least one among a border network device of a service provider and a customer network device of the virtual private network in response to receiving the first query for connectivity information, wherein at least one of the first and second queries is grouped with at least one other query for at least one among the border network device and the customer network device.

In a fifth embodiment of the present disclosure, a method of monitoring network connectivity can involve transmitting packets that are routed to one or more locations of a virtual private network utilizing Virtual Routing and Forwarding (VRF) functionality; generating queries for connectivity information from network devices of the virtual private network; and grouping the queries based at least in part on an association between the network devices.

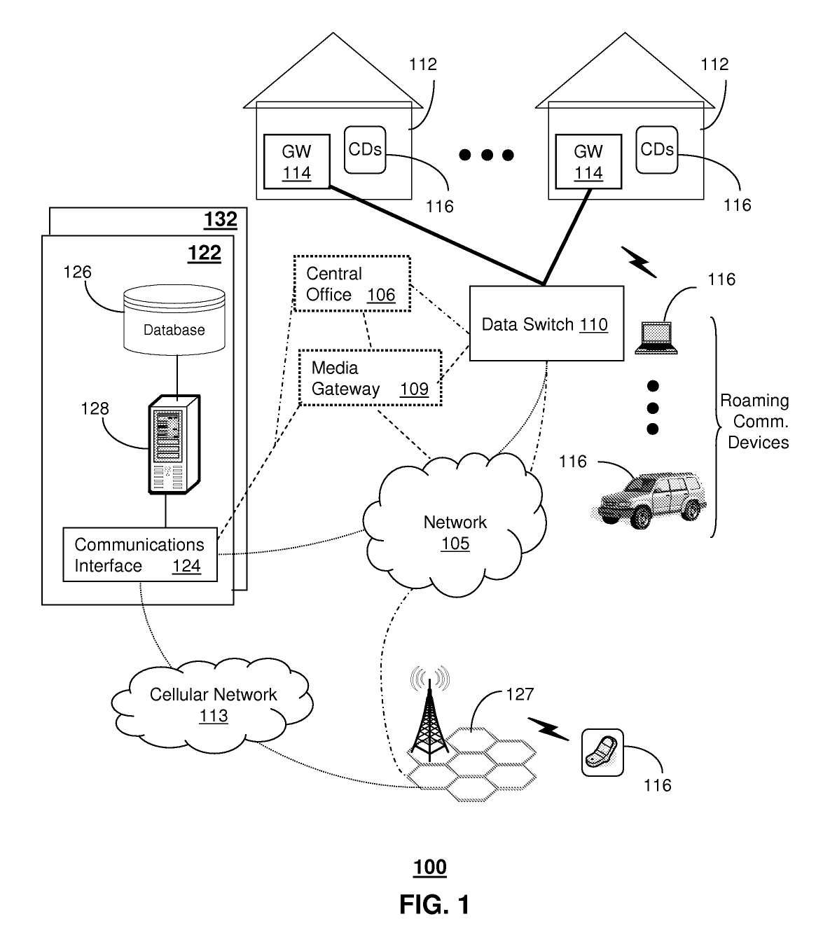

FIG. 1 depicts an exemplary embodiment of communication devices 116 communicating by way of wired and/or wireless access points (WAPs) with other communication devices and/or a network proxy 122 which collectively operate in a communication system 100. The communication device 116 can be a multimode VoIP terminal. However, the present disclosure contemplates the use of other types of communication devices, including other types of voice, video and data devices. The communication system 100 can comprise a packet-switched network 105. The packet-switched network can be an Internet Service Provider (ISP) network 105. The network 105 can be coupled to the network proxy 122, the cellular network 113 and network elements, such as network elements located in one or more of the buildings 112 representing an enterprise or residence. The ISP network 105 can utilize computing technology for transporting Internet traffic.

In an enterprise setting, the building 112 can include a gateway 114 that provides voice and/or video connectivity services between communication devices 116, such as VoIP terminals or other forms of communication devices of enterprise personnel. In a residential setting, the building 112 can include a gateway 114 represented by, for example, a residential gateway coupled to central office 106 utilizing conventional telephonic switching for processing calls with third parties.

The network proxy 122 can be used to control operations of a media gateway 109, the central office 106, the gateway 114 and a data switch 110. Communications between the network proxy 122, the communication devices 116 and other network elements of the communication system 100 can conform to any number of signaling protocols such as a session initiation protocol (SIP), SS7, or a video communications protocol such as H.323 which combines video and voice over a packet-switched network, as well as cryptographic protocols, such as transport layer security (TLS) or secure sockets layer (SSL), to provide secure communications for data transfers.

The network proxy 122 can comprise a communications interface 124 that utilizes common technology for communicating over an IP interface with the network 105, the central office 106, the media gateway 109, the cellular network 113, the data switch 110 and/or the gateway 114. By way of the communications interface 124, the network proxy 122 can direct by common means any of the foregoing network elements to establish packet switched data, voice, and/or video connections between communication devices 116 distributed throughout the communication system 100. The network proxy 122 can further comprise a memory 126 (such as a high capacity storage medium) embodied in this illustration as a database, and a controller 128 that makes use of computing technology such as a desktop computer, or scalable server for controlling operations of the network proxy 122. The network proxy 122 can operate as an IP Multimedia Subsystem (IMS) conforming in part to protocols defined by standards bodies such as 3GPP (Third Generation Partnership Protocol).

Under the control of the network proxy 122, the media gateway 109 can link packet-switched and circuit-switched technologies such as the cellular network 113 (or central office 106) and the network 105, such as an ISP network. The media gateway 109 can conform to a media gateway control protocol (MGCP) also known as H.248 defined by work groups in the Internet Engineering Task Force (IETF). This protocol can handle signaling and session management needed during a multimedia conference. The protocol defines a means of communication which converts data from the format required for a circuit-switched network to that required for a packet-switched network. MGCP can therefore be used to set up, maintain, and terminate calls between multiple disparate network elements of the communication system 100. The media gateway 109 can therefore support hybrid communication environments for communication devices 116, including VoIP terminals.

The network proxy 122 can include or be coupled with a connectivity verification system 132. The connectivity verification system 132 can comprise a communications interface, a memory (such as a high capacity storage medium), and a controller, such as in a connectivity server, that makes use of computing technology such as a desktop computer, or scalable server for controlling operations of the connectivity verification system, including verifying that a connection exists between network elements. The connectivity verification system 132 can be a separate system that is housed with or remote from the network proxy 122. In one embodiment, the connectivity verification system 132 can be incorporated into the network proxy 122, including sharing one or more common components.

The central office 106 can house common network switching equipment for distributing local and long-distance telecommunication services supplied by network 105 to buildings 112 (such as dwellings or commercial enterprises). Telecommunication services of the central office 106 can include traditional POTS (Plain Old Telephone Service) and broadband services such as HDTV, DSL, VoIP (Voice over Internet Protocol), IPTV (Internet Protocol Television), Internet services, and so on. The communication system 100 can utilize common computing and communications technologies to support circuit-switched and/or packet-switched communications, including MPLS.

Communication system 100 can comprise one or more data switches 110 or other network devices that can manage network traffic to one or more users, such as communication devices 116. The data switch 110 can be various network elements utilized for control of network traffic, including digital subscriber line access multipliers (DSLAMs), routers, and asynchronous transfer mode (ATM) switches. For illustration purposes, a single data switch 110 is shown as a stand-alone device. However, the present disclosure contemplates the data switch 110 being incorporated into other network elements. The present disclosure contemplates the use of a plurality of data switches 110 being utilized, which can each have one or more users associated therewith. The data switch 110 can be housed in the central office 106 or can be housed elsewhere, as shown in FIG. 1 for illustrative purposes.

The cellular network 113 can support voice and data services over a number of access technologies such as GSM-GPRS, EDGE, CDMA-1X, UMTS, WiMAX, software defined radio (SDR), and other known and future technologies. The cellular network 113 can be coupled to base stations 127 under a frequency-reuse plan for communicating over-the-air with roaming VoIP terminals 116.

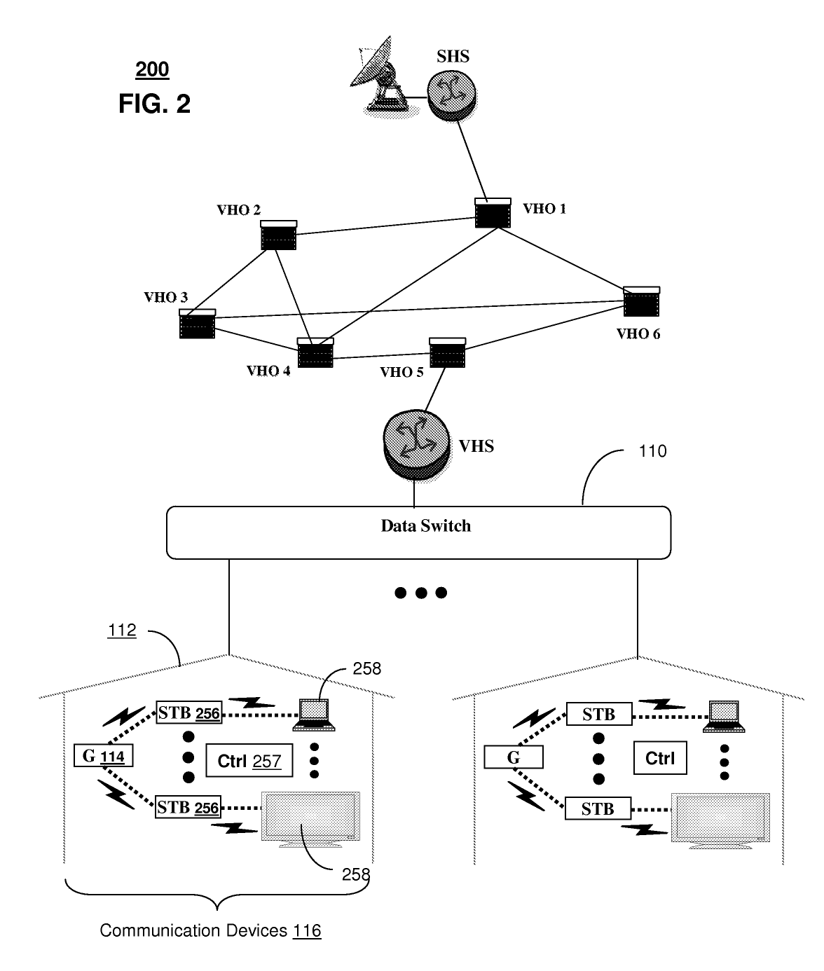

FIG. 2 depicts an exemplary embodiment of a communication system 200 embodying an IPTV service. Communication system 200 can be overlaid or operably coupled with communication system 100 as another representative embodiment of communication system 100. In a typical IPTV backbone, there is at least one super head office server (SHS) which receives national media programs from satellite and/or media servers from service providers of multimedia broadcast channels. The SHS server forwards IP packets associated with the media content to video head servers (VHS) via a network of video head offices (VHO) according to a common multicast communication method. The VHS then distributes multimedia broadcast programs to commercial and/or residential buildings 112 housing the gateway 114 (e.g., a residential gateway or RG) that distributes broadcast signals to receivers such as Set-Top Boxes (STBs) 256 which in turn present broadcast selections or media programs to media devices 258 such as computers or television units managed in some instances by a media controller 257 (e.g., an infrared or RF remote control).

Unicast traffic can also be exchanged between the STBs 256 and the subsystems of the IPTV communication system 200 for services such as video-on-demand (VoD). Although not shown, the aforementioned multimedia system can also be combined with analog broadcast distributions systems.

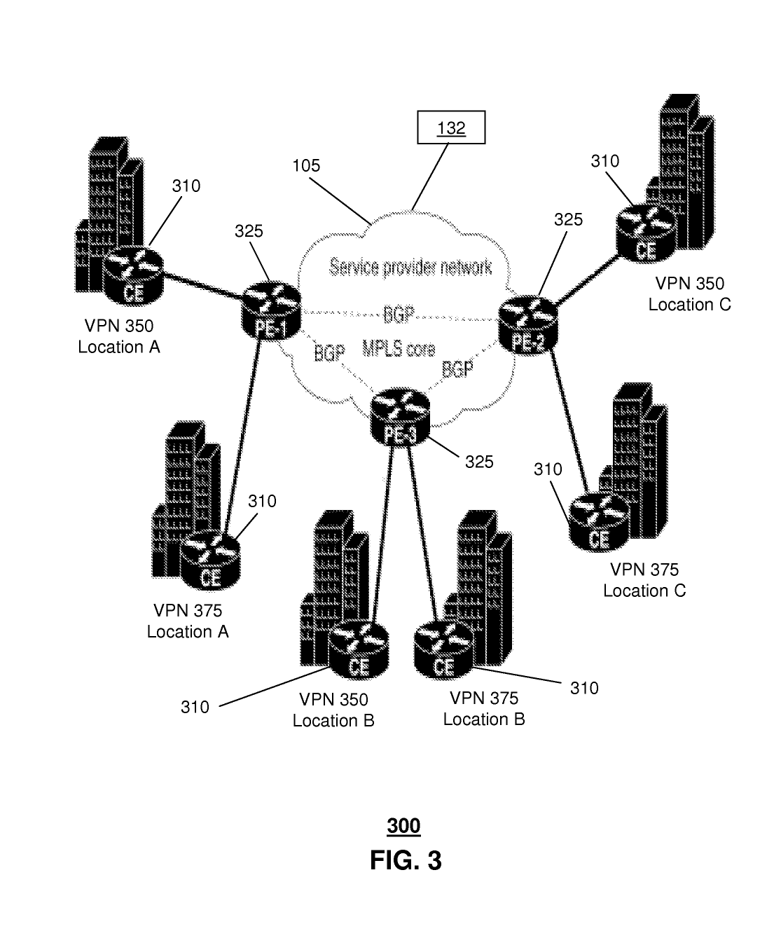

FIG. 3 depicts an exemplary embodiment of a communication system 300 embodying virtual private networks (VPNs) being provided by a service provider, such as through ISP network 105. Communication system 300 can be overlaid or operably coupled with communication systems 100 and/or 200 as another representative embodiment of the communication systems.

ISP network 105 provides a VPN 350 at remote locations A, B and C, and a VPN 375 at remote locations A, B and C. The present disclosure contemplates other numbers and configurations of VPNs and/or locations. The locations A, B and C of the VPNs 350 and 375 can be in various configurations, including a single building or portion thereof, such as building 112, or multiple buildings or portions thereof, as well as other structures or locales that comprise network elements and/or computing equipment for establishing a VPN.

The ISP network 105 can have border routers 325 coupled to network elements 310 of the locations A, B and C of the VPNs 350 and 375 (e.g., customer equipment (CE)). The border routers 325 can be coupled to the connectivity verification system 132 of network proxy 122. In one embodiment, the ISP network 105 can utilize border gateway protocol (BGP) and/or multi-protocol label switching (MPLS) for communication amongst the border routers 325, as well as between the border routers and network elements 310 or other network elements of the ISP network and/or the VPNs 350 and 375. The present disclosure contemplates managing packet transmission between locations A, B and C of the VPNs 350 and 375 by various other components and combinations of components, including hubs, gateways and switches, with or without the use of routers.

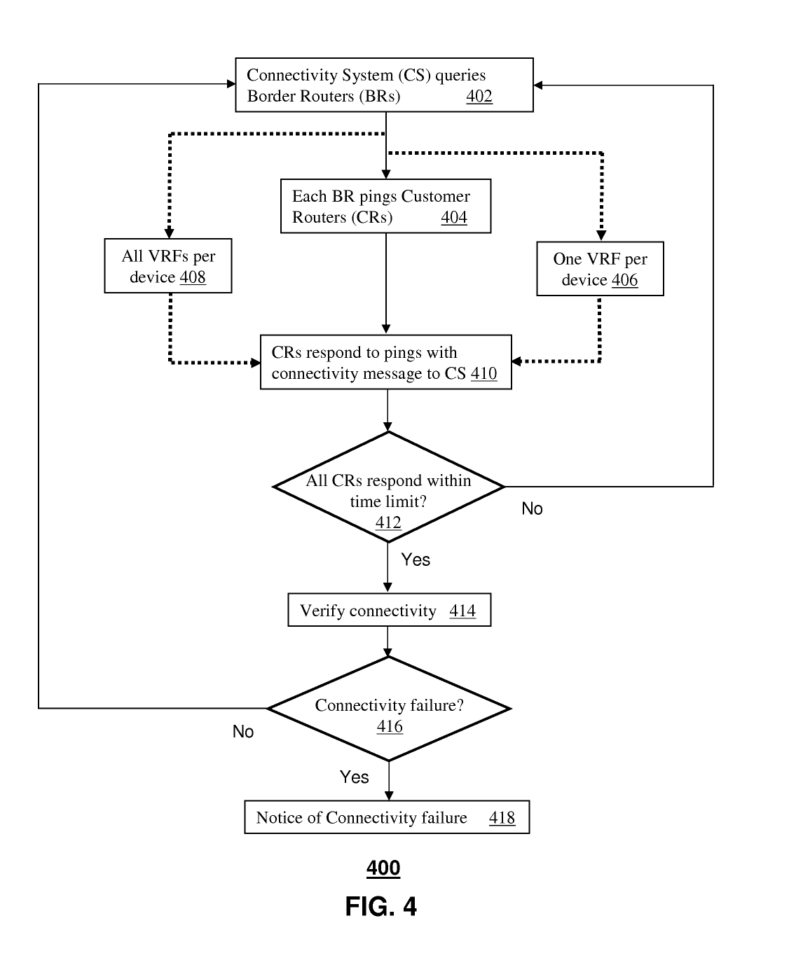

FIG. 4 depicts an exemplary method 400 operating in portions of the communication systems 100, 200 and/or 300. Method 400 has variants as depicted by the dashed lines. It would be apparent to an artisan with ordinary skill in the art that other embodiments not depicted in FIG. 4 are possible without departing from the scope of the claims described below.

Method 400 can begin with step 402 in which the connectivity system 132 queries border routers 325 that are associated with each of the locations A, B and C of the VPN 350 or 375. In response to the queries, each of the border routers 325 can poll, such as through transmitting Internet Control Message Protocol (ICMP) echo request packets (“pings”), customer routers 310 that are located on the customer side of the VPN, as in step 404. The connectivity system 132 can group the pings to improve efficiency of retrieving connection information. For example, the connectivity system 132 can utilize a thread for each router, and multiple threads on each router so that the threads can perform the pings concurrently. The threads can be grouped to reduce interference between routers during the ping transmissions and/or to reduce bandwidth usage or processor time. An association between various routers can be determined and the grouping can be based on the association. For example, the association between routers can be based upon the VRFs of each network device in order to reduce the bandwidth usage and/or the processor time. In one embodiment, the pings can be configured according to simple network management protocol. The present disclosure contemplates the use of other techniques for retrieving connectivity information from the customer routers 310, such as the use of traceroutes.

In one embodiment, polling of a single VRF per device can be used so that the total number of VRFs that need to be polled is reduced which reduces runtime of the connectivity verification process, as in step 406. In another embodiment, all of the VRFs per device can be polled, as in step 408. For example, a full mesh poll can be used where every VRF per device is polled in order to determine if traffic can be transmitted along every VRF that the current VRF is a part of.

In step 410, the customer routers 310 can respond to the pings with connectivity messages transmitted to the connectivity system 132. The connectivity messages can include a connection confirmation, a round-trip time and/or a rate of packet loss, as well as other telemetry data associated with the customer routers 310, such as bandwidth usage.

In step 412, if all of the customer routers 310 respond to the pings within a pre-determined time interval then the connectivity can be verified, as in step 414. If on the other hand, each of the customer routers 310 do not respond to the pings within the pre-determined time interval then the connectivity system can re-group or otherwise modify the queries and/or the time interval, and start the process again as back in step 402.

In step 416, if a connection failure is determined by the connectivity system 132 then a notification of the connection failure can be provided, such as to a network administrator or VPN user. If on the other hand, all connections of the locations of the VPN have been verified then method 400 can continue to monitor for connectivity by proceeding back to step 402.

From the foregoing descriptions, it would be evident to an artisan with ordinary skill in the art that the aforementioned embodiments can be modified, reduced, or enhanced without departing from the scope and spirit of the claims described below. For example, other network devices can be polled for connectivity information, including gateways, switches and hubs. As another example, a number of VRFs of all of the VRFs per device can be polled to verify connectivity. In the illustrated embodiment, the connectivity system 132 can transmit the queries to commence the pings being transmitted and can receive the connectivity information directly from the network devices. The present disclosure contemplates other components transmitting the queries and/or receiving the connectivity information, such as a dedicated server. In one embodiment, a dedicated or intermediate router or other network device can be used for pinging each of the customer routers 310 of the various remote locations of the VPN. These are but a few examples of the modifications that can be applied to the present disclosure without departing from the scope of the claims. Accordingly, the reader is directed to the claims for a fuller understanding of the breadth and scope of the present disclosure.

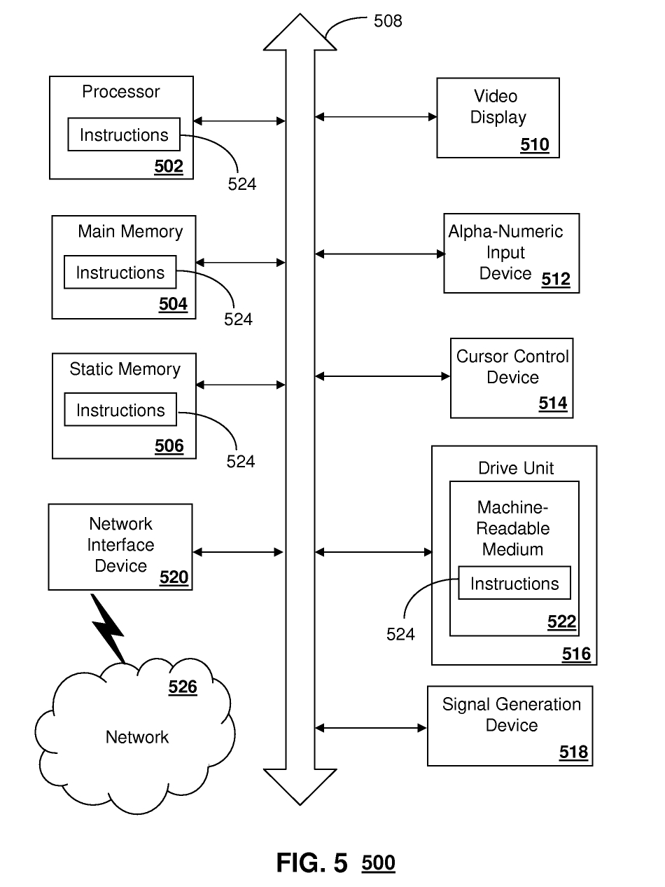

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a mass storage medium 516, a signal generation device 518 (e.g., a speaker or remote control) and a network interface device 520.

The mass storage medium 516 may include a computer-readable storage medium 522 on which is stored one or more sets of instructions (e.g., software 524) embodying any one or more of the methodologies or functions described herein, including those methods illustrated above. The computer-readable storage medium 522 can be an electromechanical medium such as a common disk drive, or a mass storage medium with no moving parts such as Flash or like non-volatile memories. The instructions 524 may also reside, completely or at least partially, within the main memory 504, the static memory 506, and/or within the processor 502 during execution thereof by the computer system 500. The main memory 504 and the processor 502 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the computer-readable storage medium 522 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium comprising computer instructions for:
grouping connectivity queries for routers comprising border routers of a service provider and customer routers of a virtual private network, the service provider providing the virtual private network with a plurality of remote locations, the customer routers being located in each of the plurality of remote locations, the grouping based at least in part on an association between the routers;
querying the border routers and the customer routers of each of the plurality of remote locations to obtain connectivity information, wherein the border routers and the customer routers utilize Virtual Routing and Forwarding (VRF) functionality; and
verifying connectivity between the plurality of remote locations based on the connectivity information.

2. The storage medium of claim 1, wherein the association between the routers is based on the VRF functionality.

3. The storage medium of claim 1, wherein the querying of the border routers and the customer routers is of one VRF of a plurality of VRFs for each of the routers.

4. The storage medium of claim 1, wherein the connectivity queries are Internet Control Message Protocol (ICMP) echo request packets.

5. The storage medium of claim 4, wherein the ICMP echo request packets are configured according to simple network management protocol.

6. The storage medium of claim 1, comprising computer instructions for determining a first grouping of connectivity queries that reduces bandwidth usage for the routers as compared to a second grouping of connectivity queries.

7. The storage medium of claim 1, wherein the querying of the border routers and the customer routers is of each VRF of a plurality of VRFs for each of the routers.

8. The storage medium of claim 7, comprising computer instructions for providing a notification when the connectivity information is not received from each VRF of the plurality of VRFs for each of the routers within a pre-determined time period.

9. The storage medium of claim 1, wherein the connectivity information comprises at least one among a connection confirmation, a round-trip time and a rate of packet loss.

10. A network device comprising a controller element to:
route packets to one or more locations of a virtual private network utilizing Virtual Routing and Forwarding (VRF) functionality; and
route a connectivity message to a connectivity server in response to receiving a query for connectivity information, wherein the query is grouped with at least one other query for at least one among a border network device of a service provider and a customer network device of the virtual private network.

11. The network device of claim 10, wherein a connectivity between a plurality of locations of the virtual private network is verified based in part on the connectivity message.

12. The network device of claim 10, wherein the query is grouped with the at least one other query based at least in part on an association between the network device and at least one of the border network device and the customer network device.

13. The network device of claim 12, wherein the association between the network device and the at least one of the border network device and the customer network device is based on the VRF functionality of the network device.

14. The network device of claim 10, wherein the connectivity message is based upon one VRF of a plurality of VRFs of the network device.

15. The network device of claim 10, wherein the query is an Internet Control Message Protocol (ICMP) echo request packet configured according to simple network management protocol.

16. The network device of claim 10, wherein the connectivity message is based upon each VRF of a plurality of VRFs of the network device.

17. The network device of claim 10, wherein the connectivity message comprises at least one among a connection confirmation, a round-trip time and a rate of packet loss.

18. The network device of claim 10, comprising one among a router, a gateway, a switch and a hub.

19. The network device of claim 1, wherein an acknowledgement message is received in response to receipt of the connectivity message by the connectivity server.

20. A communication device comprising a controller element to:
transmit packets that are routed to one or more locations of a virtual private network utilizing Virtual Routing and Forwarding (VRF) functionality, wherein a connectivity between a plurality of locations of the virtual private network is verified based in part on a connectivity message that is sent by a network device to a connectivity server in response to receiving a query for connectivity information, and wherein the query is grouped with at least one other query for at least one among a border network device of a service provider and a customer network device of the virtual private network.

21. The communication device of claim 20, wherein the network device, the border network device and the customer network device comprise at least one among a router, a gateway, a switch and a hub.

22. The communication device of claim 20, wherein the query is grouped with the at least one other query based at least in part on an association between the network device and at least one of the border network device and the customer network device.

23. The communication device of claim 20, wherein the connectivity message is based upon one VRF of a plurality of VRFs of the network device.

24. The communication device of claim 20, wherein an acknowledgement message is generated and transmitted based upon receipt of the connectivity message.

25. A network device comprising a controller element to:
route packets to one or more locations of a virtual private network utilizing Virtual Routing and Forwarding (VRF) functionality;
receive a first query for connectivity information; and
route a second query for connectivity information to at least one among a border network device of a service provider and a customer network device of the virtual private network in response to receiving the first query for connectivity information, wherein at least one of the first and second queries is grouped with at least one other query for at least one among the border network device and the customer network device.

26. A method of monitoring network connectivity comprising:
transmitting packets that are routed to one or more locations of a virtual private network utilizing Virtual Routing and Forwarding (VRF) functionality;
generating queries for connectivity information from network devices of the virtual private network; and
grouping the queries based at least in part on an association between the network devices.

27. The method of claim 26, comprising:
verifying a connectivity between a plurality of locations of the virtual private network based in part on a connectivity message that is sent by a network device to a connectivity server in response to receiving at least one of the queries, wherein the queries are grouped with at least one other query for at least one among a border network device of a service provider and a customer network device of the virtual private network.

28. The method of claim 26, comprising adjusting the grouping of the queries.
